(19) United States
(12) Patent Application Publication
(10) Pub. No.: US 2013/0066908 A1
(43) Pub. Date: Mar. 14, 2013

(54) SYSTEM AND METHOD FOR SHARING MOBILE DEVICE CONTENT

(71) Applicant: Karthigesu Niranjan, Ottawa (CA)

(72) Inventor: Karthigesu Niranjan, Ottawa (CA)

(73) Assignee: RESEARCH IN MOTION LIMITED, Waterloo, ON (CA)

(21) Appl. No.: 13/635,377

(22) PCT Filed: Jul. 4, 2011
(86) PCT No.: PCT/CA2011/050407

§ 371 Date: Sep. 14, 2012

(51) Int. Cl. G06F 17/30

(52) U.S. Cl. 707/770; 707/E17.014; 707/E17.032

(57) ABSTRACT

A method, system and mobile communication device for searching, sharing and accessing content stored on a mobile or computing device. The exemplary embodiments disclosed herein allow a mobile communication device (402) (“content-requesting device”) to access other, published content made available on other mobile devices (404, 406) and computers (408) (“content-storing device”). The user of the content-storing device (404, 406, 408) selects all or a portion of the content that will be made available (“published”) to other content-requesting devices (402). When a user of a content-requesting device (402) wishes to search for content on other content-storing devices (404, 406, 408) he or she can send out a search request, or, in the alternative, be notified when other content-storing devices (404, 406, 408) have published content available for access. The content-requesting device (402) can then search for and access published content. A mobile device can be both a content-requesting device and a content-storing device.

### FIELD OF THE TECHNOLOGY

The example embodiments disclosed herein relate to electronic devices, including mobile communication devices and computing devices. More particularly, the example embodiments relate to a method and system for allowing mobile communication devices to access and share content with other mobile communication devices and computing devices.

### BACKGROUND

With the advent of more robust electronic systems, advancements of electronic devices are becoming more prevalent. Electronic devices can provide a variety of functions including, for example, telephonic functions, electronic messaging functions and other personal information manager (PIM) application functions. Electronic devices can include mobile electronic devices, such as cellular telephones, smart telephones, personal digital assistants (PDAs), as well as laptop computers, and desktop computers.

Whereas in the past, such mobile electronic devices typically accommodated voice transmission (cell phones) or text transmission (pagers and PDAs), today's consumers often demand a combination device capable of performing both types of transmissions, including even sending and receiving e-mail. Today's mobile electronic devices are also capable of storing content such as contact information, music, photographs, calendars, and other information that others, e.g., family, friends and business colleagues, may wish to access, on demand. Many current systems allow mobile electronic devices to access information from other devices such as mobile phones or desktop computers via the use of a centralized computer, via a server or central communication hub, or through a social network that allows for content exchange. It would be useful to be able to search and access mobile electronic device and computer content directly on demand without the use of an intermediary data exchange entity.

### BRIEF DESCRIPTION OF THE DRAWINGS

FIG. 1 is a communication system for mobile communication devices according to an example embodiment;

FIG. 2 is a mobile communication device according to an example embodiment;

FIG. 3 is a block diagram of the mobile communication device illustrated in FIG. 2, according to an example embodiment;

FIG. 4 is a block diagram illustrating the interaction between the file sharing system and four devices according to an example embodiment;

FIG. 5 is an block diagram illustrating how a content-storing device publishes searchable content according to an example embodiment;

FIG. 6 is a block diagram illustrating how a content-requesting device searches through available published content according to an example embodiment;

FIG. 7 is a block diagram illustrating the components of the file sharing system according to an example embodiment; and

FIG. 8 is a flowchart illustrating the steps performed by an example embodiment.

### DETAILED DESCRIPTION

Reference will now be made in detail to example embodiments. Each is provided by way of explanation only, not as a limitation of any of the disclosed example embodiments. It will be apparent to those skilled in the art that various modifications and variations can be made without departing from the scope or spirit of the example embodiments disclosed herein. For instance, features described as part of one example embodiment can be used on another example embodiment to yield a still further example embodiment.

The example embodiments disclosed herein are directed to a file sharing framework for mobile communication devices and other computing devices. The disclosed framework allows mobile communication device users to access other, published content made available on other mobile devices and computers (collectively “computing devices”). Users using computing devices can select the content that they wish to make available (i.e., “publish”) to other users. When a user using a mobile device wishes to search for content stored on other computing devices the requesting mobile device can send out a request, or, in the alternative, be notified when other computing devices containing published content are within a given proximity, or when they have published new content. A file sharing system coordinates the granting of access permissions and transfer of content. The requesting device is presented with a display that lists the some or all of the content made available by one or more other computing devices. The user of the requesting device can then select which content they wish to access. This content is made available on the requesting device.

In one aspect, a method of sharing content between a requesting mobile communication device and a content-storing device is disclosed. The method includes granting access permission to at least one mobile communication device, publishing selected content from content stored on the content-storing device, the published content available for searching by the requesting mobile communication device having access permission, determining whether the requesting mobile communication device was granted permission to access the content, and if the requesting mobile communication device was granted access permission, providing the requesting mobile communication device with access to the published content.

In another aspect, a communication system for sharing content is disclosed. The system includes at least one content-requesting device in communication with at least one content-storing device. The system includes a permissions module for granting access permission to specified content-requesting devices in order to access content stored on the at least one content-storing device, a content-publishing module for publishing content stored on the at least one content-storing device, the published content available for searching by the at least one content-requesting device having access permission, and an access module for providing the at least one content-requesting device with access to the published content.

In yet another aspect, a mobile communication device having stored content thereon is disclosed. The mobile communication device includes a permissions module for granting access permission to specified content-requesting devices in order to access the content, a content-publishing module for publishing the content, the published content available for searching by the content-requesting device having access permission, and an access module for providing the content-requesting device with access to the published content.

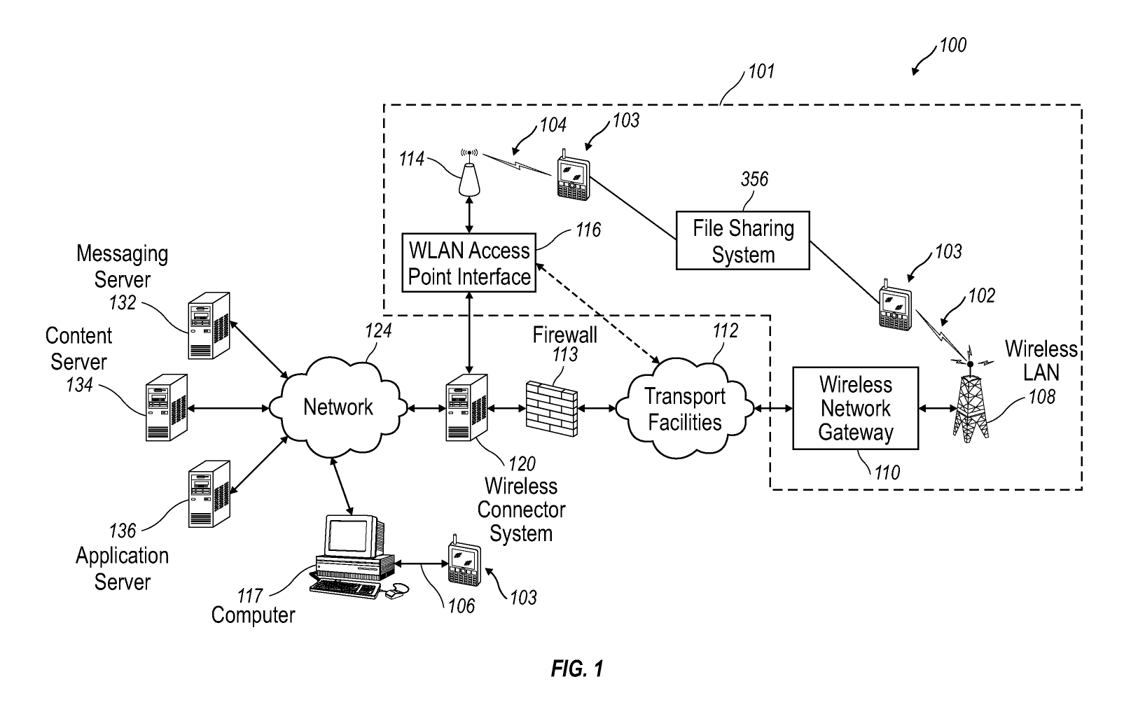

FIG. 1 illustrates an example embodiment of an operating environment for a communication system 100 that can include a number of mobile communication devices 103. The communication system 100 can be coupled to the mobile communication devices 103 in any of several different ways. The mobile communication devices 103 can be coupled to a wireless network 101, such as one or more of a Wireless Wide Area Network (WWAN) 102 and a Wireless Local Area Network (WLAN) 104, among other suitable network arrangements. In some example embodiments, the mobile communication devices 103 can be configured to communicate over both the WWAN 102 and WLAN 104, and to roam between these networks. In some example embodiments, the wireless network 101 can comprise multiple WWANs 102 and WLANs 104, among other configurations. Mobile communication devices 103 can also search, access, and exchange data files via a file sharing system 356, which is discussed in greater detail below. File sharing system 356 can be a separate entity as shown in FIG. 1 or can be incorporated as part of mobile communication device 103.

The WWAN 102 can be implemented as any suitable wireless access network technology. By way of example, but not limitation, the WWAN 102 can be implemented as a wireless network that includes a number of transceiver base stations 108 (one of which is shown in FIG. 1), where each of the base stations 108 provide wireless Radio Frequency (RF) coverage to a corresponding area or cell. The WWAN 102 typically is operated by a mobile network service provider that provides subscription packages to users of the mobile communication devices 103. In some example embodiments, the WWAN 102 can conform to one or more of the following wireless network types: Mobitex Radio Network; DataTAC; GSM (Global System for Mobile Communication); GPRS (General Packet Radio System); TDMA (Time Division Multiple Access); CDMA (Code Division Multiple Access); CDPD (Cellular Digital Packet Data); iDEN (integrated Digital Enhanced Network); Ev-DO (Evolution-Data Optimized); CDMA2000; EDGE (Enhanced Data rates for GSM Evolution); UMTS (Universal Mobile Telecommunication Systems); HSPDA (High-Speed Downlink Packet Access); IEEE 802.16e (also referred to as Worldwide Interoperability for Microwave Access or “WiMAX”), or various other networks. While WWAN 102 is described herein as a “Wide-Area” network, that term is intended also to incorporate wireless Metropolitan Area Networks (WMAN) or other similar technologies for providing coordinated service wirelessly over an area larger than that covered by typical WLANs.

The WWAN 102 can communicate with a wireless network gateway 110 that couples the mobile communication devices 103 to transport facilities 112. The transport facilities 112 couple the mobile communication devices 103 to a wireless connector system 120. The transport facilities 112 can include one or more private networks or lines, the Internet, a virtual private network, or any other suitable network, among other transport facilities. The wireless connector system 120 can be operated, for example, by an organization or enterprise such as a corporation, university, or governmental department, among other organizations or enterprises, which allow access to a network 124, such as an internal or enterprise network (e.g., an intranet) and its resources. Alternatively, the wireless connector system 120 can be operated by a mobile network provider. In some example embodiments, the network 124 can be realized using the Internet rather than, or in addition to, an internal or enterprise network.

The wireless network gateway 110 provides an interface between the wireless connector system 120 and the WWAN 102. The wireless network gateway 110 facilitates communication between the mobile communication devices 103 and other devices (not shown) that can be connected, directly or indirectly, to the WWAN 102. Accordingly, communications sent via the mobile communication devices 103 are transported via the WWAN 102, the wireless network gateway 110 and the transport facilities 112 to the wireless connector system 120. Communications sent from the wireless connector system 120 are received by the wireless network gateway 110 and transported via the WWAN 102 to the mobile communication devices 103.

According to one example embodiment, the WLAN 104 includes a wireless network that conforms to IEEE 802.11x standards (sometimes referred to as Wi-Fi™) such as, for example, the IEEE 802.11a, 802.11b and/or 802.11g standard. One of ordinary skill in the art will readily appreciate that other communication protocols can be used for the WLAN 104, such as, IEEE 802.11n, IEEE 802.16e (also referred to as Worldwide Interoperability for Microwave Access or “WiMAX”), or IEEE 802.20 (also referred to as Mobile Wireless Broadband Access), among other communication protocols. The WLAN 104 includes one or more wireless RF Access Points (AP) 114 (one of which is shown in FIG. 1) that collectively provide a WLAN coverage area.

The WLAN 104 can be a user's personal network, an enterprise network, or a hotspot offered by an Internet service provider (ISP), a mobile network provider, or a property owner in a public or semi-public area, for example. The access points 114 can be connected to an access point (AP) interface 116 that can connect to the wireless connector system 120 directly or indirectly. A direct connection can be provided when the access point 114 is part of an enterprise WLAN 104 in which the wireless connector system 120 resides. An indirect connection can be provided via the transport facilities 112, as indicated by the dashed signal line in FIG. 1, if the access point 114 is a personal Wi-Fi network or Wi-Fi hotspot. In this case, a mechanism, such as a virtual private network (VPN), can be used for securely connecting to the wireless connector system 120. The AP interface 116 can provide translation and routing services between the access points 114 and the wireless connector system 120 to facilitate communication, directly or indirectly, with the wireless connector system 120.

The wireless connector system 120 can be implemented as one or more servers, and is typically located behind a firewall 113. The wireless connector system 120 manages communications, including email, Hypertext Transfer Protocol (HTTP), and HTTP Secure (HTTPS) communications to and from a set of managed mobile communication devices 103. The wireless connector system 120 also provides administrative control and management capabilities over users and mobile communication devices 103 that can connect to the wireless connector system 120.

The wireless connector system 120 allows the mobile communication devices 103 to access the network 124 and connected resources and services such as a messaging server 132, for example, a Microsoft Exchange Server®, IBM Lotus Domino®, or Novell GroupWise™ email server; a content server 134 for providing content, such as Internet content or content from an organization's internal servers; application servers 136 for implementing server-based applications, such as instant messaging (IM) applications to mobile communication devices 103, and intranet file services; among other connected resources and services.

The wireless connector system 120 typically provides a secure exchange of data (e.g., email messages, personal information manager (PIM) data, and IM data) with the mobile communication devices 103. In some example embodiments, communications between the wireless connector system 120 and the mobile communication devices 103 can be encrypted. In some example embodiments, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data. In some example embodiments, the private encryption key is stored only in the user's mailbox on the messaging server 132 and on the mobile communication device 103, and can typically be regenerated by the user on mobile communication devices 103. Data sent to the mobile communication devices 103 is encrypted by the wireless connector system 120 using the private encryption key retrieved from the user's mailbox. The encrypted data, when received on the mobile communication devices 103, is decrypted using the private encryption key stored in memory. Similarly, data sent to the wireless connector system 120 from the mobile communication devices 103 is encrypted using the private encryption key stored in the memory of the mobile communication device 103. The encrypted data, when received on the wireless connector system 120, is decrypted using the private encryption key retrieved from the user's mailbox.

The wireless network gateway 110 is adapted to send data packets received from the mobile communication device 103 over the WWAN 102 to the wireless connector system 120. The wireless connector system 120 then sends the data packets to the appropriate connection point such as the messaging server 132 or the content servers 134 or the application server 136, or a combination of these. Conversely, the wireless connector system 120 can send data packets received, for example, from the messaging server 132 or the content servers 134 or the application servers 136 or any combination of these, to the wireless network gateway 110 that then transmit the data packets to the destination mobile communication device 103. The AP interfaces 116 of the WLAN 104 provide similar sending functions between the mobile communication device 103, the wireless connector system 120 and network connection point, such as the messaging server 132, the content server 134, the application server 136, or any combination of these.

The network 124 can comprise a private local area network (LAN), metropolitan area network (MAN), wide area network (WAN), the public Internet or combinations thereof. The network 124 can include virtual networks constructed using any of these networks, alone or in combination. Alternatively, the mobile communication device 103 can connect to the wireless connector system 120 using a computer 117, such as a desktop or a notebook computer, via the network 124. A link 106 can be provided between the mobile communication device 103 and the computer 117 for exchanging information between the mobile communication device 103 and a computer 117 connected to the wireless connector system 120. The link 106 can include one or both of a physical interface or a short-range wireless communication interface.

The physical interface can comprise one or a combination of an Ethernet connection, a Universal Serial Bus (USB) connection, a Firewire™ (also known as an IEEE 1394 interface) connection, or other serial data connections, via respective ports or interfaces of the mobile communication device 103 and computer 117. The short-range wireless communication interface can be a personal area network (PAN) interface. A personal area network is a wireless point-to-point connection implemented without physical cables to connect the two end points. The short-range wireless communication interface can include one or a combination of an infrared (IR) connection, such as an Infrared Data Association (IrDA) connection, a short-range radio frequency (RF) connection, such as one specified by IEEE 802.15.1 or the BLUETOOTH® special interest group, or IEEE 802.15.3a, also referred to as UltraWideband (UWB), or other PAN connection.

It will be appreciated that the above-described communication system 100 is provided for illustration purposes only. The above-described communication system 100 can be implemented using any of a multitude of network configurations for use with the mobile communication devices 103. Suitable variations of the communication system 100 will be readily appreciated by a person of ordinary skill in the art and are intended to fall within the scope of the present example embodiments.

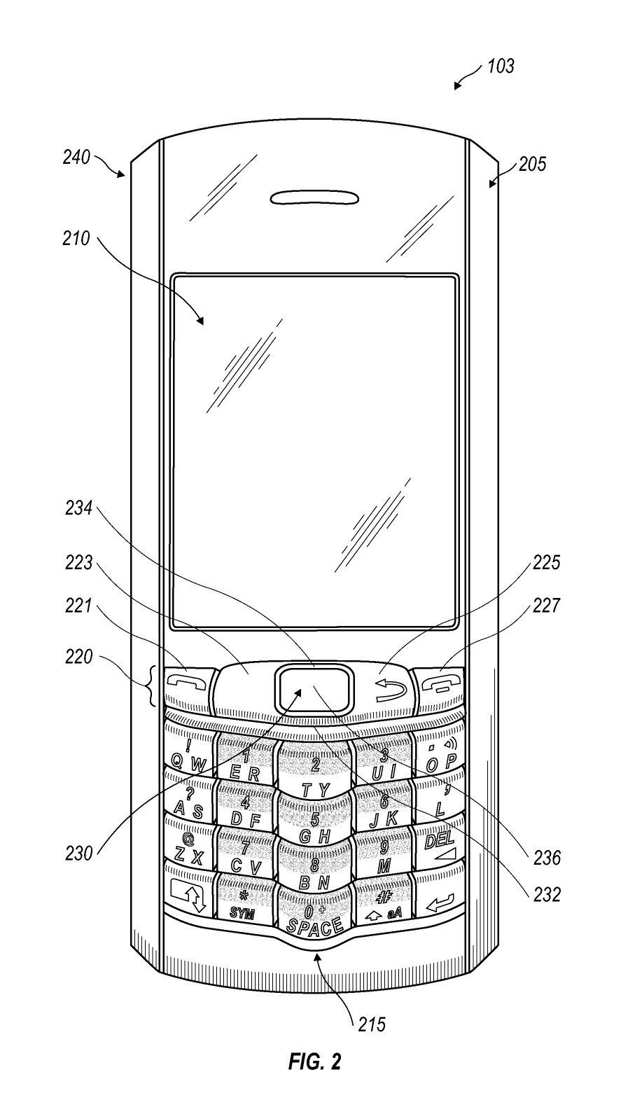

FIG. 2 illustrates a front view of mobile communication device 103 according to one example embodiment. While the illustrated example embodiment depicts the mobile communication device 103 as a “smart phone”, the example embodiment supports the mobile communication device 103 being a personal digital assistant (PDA), a laptop computer, a tablet computer, or other mobile communication device capable of sending and receiving communication messages, including but not limited to email, text and voice. The mobile communication device 103 can comprise a “unibody” structure, also known to those skilled in the art as a “candy-bar” configuration. In alternate example embodiments, the mobile communication device 100 can include a “clamshell” or a “slider” configuration, or the like.

In the example embodiment, the mobile communication device 103 comprises a front face 205 having a display 210 located above an input user interface, such as a keyboard 215. The keyboard 215 comprises a plurality of keys that are actuable to provide data input via tactile pressure. The mobile communication device 103 further comprises a row of programmable keys 220 configured to perform selected functions as is known in the art. For example, programmable keys 220 can include a call send key 221, a menu key 223, an escape key 225 and a call end key 227, and the like.

According to one example embodiment, the mobile communication device 103 can include a navigation module 230 that generates signals for navigating content on the display 210. The navigation module 230 can include, for example, an optical navigation pad, a trackball, etc. and be structured to enable two-dimensional or three-dimensional navigation on the display 210, among enabling other functions. For example, the navigation module 230 can include one or more sensor arrays having capacitive sensors or optical sensors, among other sensor types. The sensor arrays can generate signals for instructing cursor movement in substantially any direction on the display 210.

The navigation module 230 can include a cover 232 that is exteriorly located on the front face 205 of the mobile communication device 103. This location allows the navigation module 230 to be thumb-actuable or finger-actuable, similar to the keys on the keyboard 215 and the programmable keys 220. The cover 232 can include at least one decorative ring 234 that defines a tracking window 236 and outlines a perimeter of the underlying sensor arrays. As a result, users of the mobile communication device 103 receive a visual indication of the sensing area for the navigation module 230.

The cover 232 can be constructed with sufficient flexibility to enable actuation of the navigation module 230 by applying a force thereto. For example, the cover 232 can be constructed to flex in a direction perpendicular to the surface when a depression force is applied thereto. The cover 232 is also constructed with sufficient rigidity to provide support for objects that track along the tracking window 236. The navigation module 230 can be located on the front face 205 of the mobile communication device 103 and can be positioned in an area between the keyboard 215 and the display 210. In this location, the navigation module 230 can avoid interfering with the keyboard 215 during keyboarding. Furthermore, in this location, the navigation module 230 does not block the operator's view of the display 210 during use. One of ordinary skill in the art will readily appreciate that the navigation module 230 can be positioned at other locations on the mobile communication device 103.

The mobile communication device 103 optionally includes a reduced QWERTY keyboard 232. Alternatively, the mobile communication device 103 can include other keyboard configurations, including a full size keyboard or a virtual keyboard provided on a touch screen display (not shown). Each key of the keyboard 215 can be associated with at least one alphabetic character, numeral or command, among other data item. The commands can include a space command or a return command, among other commands. The plurality of the keys can include alphabetic characters and can be arranged in various known layouts, including a QWERTY layout (as shown in FIG. 2), a QZERTY layout, a QWERTZ layout, an AZERTY layout, a Dvorak layout, a Russian keyboard layout, a Chinese keyboard layout, or other known layouts. These known layouts are provided by way of example and other known layouts are considered within the scope of the example embodiments disclosed herein. The keyboard layout can be selected based on a desired geographical region of operation. Additionally, the keyboard 215 can be interchangeable such that a user can switch between keyboard layouts.

The mobile communication device 103 can include a body 240 that is sized to facilitate hand-held use. The display 210 can be provided on the front face 205 of the body 240 to enable data display and to facilitate sending and receiving communication through a network, including voice and data messages. The mobile communication device 103 can include a camera or video recorder to enable recording of digital images.

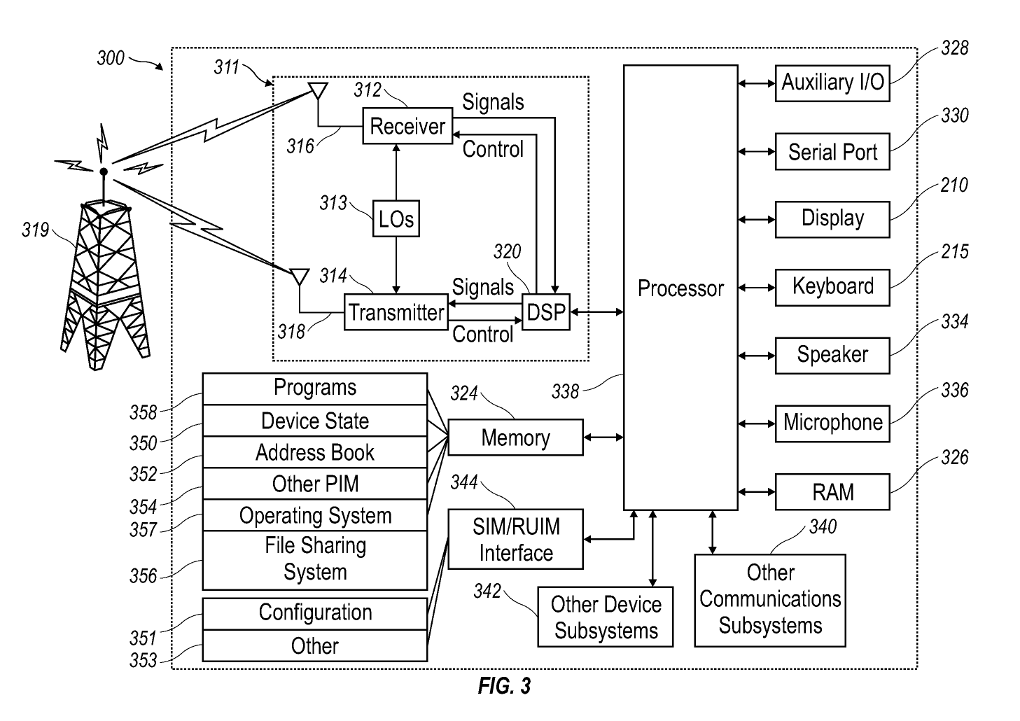

FIG. 3 illustrates a block diagram 300 of the mobile communication device 103 in accordance with an example embodiment. The mobile communication device 103 includes a processor 338 that controls operations of the mobile communication device 103. A communication module 311 performs communications, including transmission and reception, with the wireless network 319. The processor 338 can be communicatively coupled to an auxiliary input/output (I/O) subsystem 328 of the mobile communication device 103. In at least one example embodiment, the processor 338 can be communicatively coupled to a serial port 330, such as a Universal Serial Bus port, that enables communications with other devices or systems. The user interface or display 210 can be communicatively coupled to the processor 338 for displaying information to an operator of the mobile communication device 103.

When the mobile communication device 103 is equipped with a keyboard 215, the keyboard 215 also can be communicatively coupled with the processor 338. The mobile communication device 103 can include a speaker 334, a microphone 336, a random access memory (RAM) 326, and memory 324, which can be, for example flash memory, among other components. These components can be communicatively coupled to the processor 338. Other components can be provided on the mobile communication device 103 and these other components can be optionally communicatively coupled to the processor 338. Other communication subsystems 340 and other communication device subsystems 342 are generally indicated as being functionally connected with the processor 338 as well. An example of a communication subsystem 340 includes a short range communication system, such as a BLUETOOTH® communication module or a WI-FI® communication module, such as a communication module in compliance with IEEE 802.11b, and associated circuits and components. Additionally, the processor 338 can be configured to perform operating system functions and enable the execution of programs on the mobile communication device 103. In some example embodiments, less than all of the above components can be included in the mobile communication device 103. For example, in at least one example embodiment, the keyboard 215 is not provided as a separate component and is instead integrated with a touch screen as described below.

The auxiliary I/O subsystem 328 can take the form of a variety of different navigation tools, including multi-directional or single-directional navigation tools. The navigation tools can include a trackball navigation tool, a thumbwheel, a navigation pad, a joystick or a touch-sensitive interface, among other I/O interfaces. According to one example embodiment, the navigation tool can include a trackball navigation module 230, as illustrated in the example embodiment shown in FIG. 2. These navigation tools can be located on the front surface of the mobile communication device 103 or can be located on any exterior surface of the mobile communication device 103.

Other auxiliary I/O subsystems can include external display devices and externally connected keyboards (not shown). While the above examples have been provided in relation to the auxiliary I/O subsystem 328, other subsystems capable of providing input or receiving output from the communication device 103 are considered within the scope of this example embodiment. Additionally, other keys can be placed along the side of the mobile communication device 103 to function as escape keys, volume control keys, scrolling keys, power switches, or user programmable keys, and can likewise be programmed accordingly.

The keyboard 215 can include a plurality of keys that are physical in nature, such as actuable buttons. Alternatively, the keyboard 215 can be virtual or software in nature, typically constituted by representations of physical keys on the user display 210 (referred to herein as “virtual keys”). It is also contemplated that user input can be provided as a combination of these two types of keys. Each key of the plurality of keys can be associated with at least one action, which can be the input of a character, a command or a function. In this context, “characters” are contemplated to exemplarily include alphabetic letters, language symbols, numbers, punctuation, insignias, icons, pictures, or blank space, among other characters.

In the case of virtual keys, the indicia for the respective keys can be shown on the user interface or display 210. According to one example embodiment, the virtual keys can be enabled by touching the display screen 210, for example, with a stylus, finger, or other pointer, to generate the character or activate the indicated command or function. Some examples of display screens 210 capable of detecting a touch include resistive, capacitive, projected capacitive, infrared and surface acoustic wave (SAW) touch screens.

Physical and virtual keys can be combined in many different ways, as appreciated by those skilled in the art. In one example embodiment, the physical and virtual keys can be combined, such that the plurality of enabled keys for a particular program or feature of the mobile communication device 103 are shown on the display screen 210 in the same configuration as the physical keys. Using this configuration, the operator can select the appropriate physical key corresponding to what is shown on the display screen 210. Thus, the desired character, command or function is obtained by depressing the physical key corresponding to the character, command or function displayed at a corresponding position on the display screen 210, rather than touching the display screen 210.

Furthermore, the mobile communication device 103 can be equipped with components that enable operation of various programs. According to one example embodiment, memory 324 can be provided to store an operating system 357, device programs 358, and data. The operating system 357 is generally configured to manage other programs 358. The programs 358 can be stored in memory 324 and can be executable on the processor 338. The operating system 357 honors requests for services made by the programs 358 through predefined program interfaces, among other request types. More specifically, the operating system 357 typically determines the order in which the multiple programs 358 are executed on the processor 338. The operating system 357 also determines the execution time allotted for each program 358, manages sharing of the memory 324 among the multiple programs, and handles input and output to and from other device subsystems 342, among performing other operations.

Additionally, operators can interact directly with the operating system 357 through a user interface. Interactions can be facilitated by input devices, including the keyboard 215 and the display screen 210. While in an example embodiment of the operating system 357 can be stored in memory 324, the operating system 357 in other example embodiments can be stored in a read-only memory (ROM) or similar storage element (not shown). As those skilled in the art will appreciate, the operating system 357, device program 358 or parts thereof can be loaded in a RAM 326 or other volatile memory. In some example embodiments, memory 324 can include programs 358 for execution on the mobile communication device 103, including an address book 352, a personal information manager (PIM) 354, or a device state 350, among other programs. Furthermore, the programs 358, including data, can be segregated upon storage in memory 324 of the mobile communication device 103.

File sharing system 356, which will be discussed in greater detail below, provides mobile communication device 103 with the ability to share stored files with other mobile communication devices 103. File sharing system 356 assists in making content stored on mobile communication device 103 searchable and accessible my other mobile communication devices 103, provides other devices with access permissions, sends notifications to other devices 103 when published content has become available and generates search requests in order to search and access content stored in other mobile communication devices 103 and computers.

When the mobile communication device 103 is enabled for two-way communication within the wireless communication network 319, it can send and receive signals from a mobile communication service. Examples of communication systems enabled for two-way communication include, but are not limited to, General Packet Radio Service (GPRS) networks; Universal Mobile Telecommunication Service (UMTS) networks; Enhanced Data for Global Evolution (EDGE) networks; Code Division Multiple Access (CDMA) networks; High-Speed Packet Access (HSPA) networks; Universal Mobile Telecommunication Service Time Division Duplexing (UMTS-TDD) networks; Ultra Mobile Broadband (UMB) networks; Worldwide Interoperability for Microwave Access (WiMAX) networks, or other networks that can be used for combined data and voice capabilities or separate data and voice capabilities. For the communication systems listed above, the mobile communication device 103 can use a unique identifier to enable the mobile communication device 103 to transmit and receive signals from the communication network 319. Other systems can not use such identifying information. For example, GPRS, UMTS, and EDGE use a Subscriber Identity Module (SIM) in order to allow communication with the communication network 319. Likewise, most CDMA systems use a Removable User Identity Module (RUIM) in order to communicate with the CDMA network. The RUIM and SIM card can be used in multiple different mobile communication devices 103. The mobile communication device 103 can be able to operate some features without a SIM/RUIM card, but it will not be able to communicate with the network 319. A SIM/RUIM interface 344 can be located within the mobile communication device 103 to allow for removal or insertion of a SIM/RUIM card (not shown). The SIM/RUIM card features memory and can hold key configurations 351 and other information 353, such as identification and subscriber-related information. With a properly enabled mobile communication device 103, two-way communication can be performed between the mobile communication device 103, and the communication network 319.

If the mobile communication device 103 is enabled as described above or the communication network 319 does not use such enablement, the two-way communication enabled mobile communication device 103 can be configured to both transmit and receive information from the communication network 319. The communication transfer can be performed to or from the mobile communication device 103. In order to communicate with the communication network 319, the mobile communication device 103 can be equipped with an integral or internal antenna 318 for transmitting signals to the communication network 319. Likewise, the mobile communication device 103 can be equipped with another antenna 316 for receiving communication from the communication network 319. According to one example embodiment, these antennas (316, 318) can be combined into a single antenna (not shown). As one skilled in the art would appreciate, the antenna or antennas (316, 318) in another example embodiment can be externally mounted on the mobile communication device 103.

When equipped for two-way communication, the mobile communication device 103 can include the communication module 311 that supports the operational needs of the mobile communication device 103. The communication module 311 can include a transmitter 314 and a receiver 312 including an associated antenna or antennas (316, 318) as described above, local oscillators (LOs) 313, and a processing module that in the presently described example embodiment is a digital signal processor (DSP) 320.

It is contemplated that communication between the mobile communication device 103 and the wireless network 319 can be any type of communication that both the wireless network 319 and mobile communication device 103 are enabled to support. In general, these communications can be classified as voice and data communications. Voice communication generally refers to communication in which signals for audible sounds are transmitted through the communication network 319 by the mobile communication device 103. Data communication generally refers to all other types of communication that the mobile communication device 103 is capable of performing within the constraints of the wireless network 319.

FIGS. 1, 2 and 3 are examples only and those persons skilled in the art will appreciate that additional elements and modifications can be necessary to make the mobile communication device 103 operate in particular network environments. The illustrated example embodiments disclose the mobile communication devices 103 as smart phones. Alternative example embodiments contemplate that the communication devices 103 can include personal digital assistants (PDA), tablet computers, laptop computers, or other communication devices capable of sending and receiving communications and content.

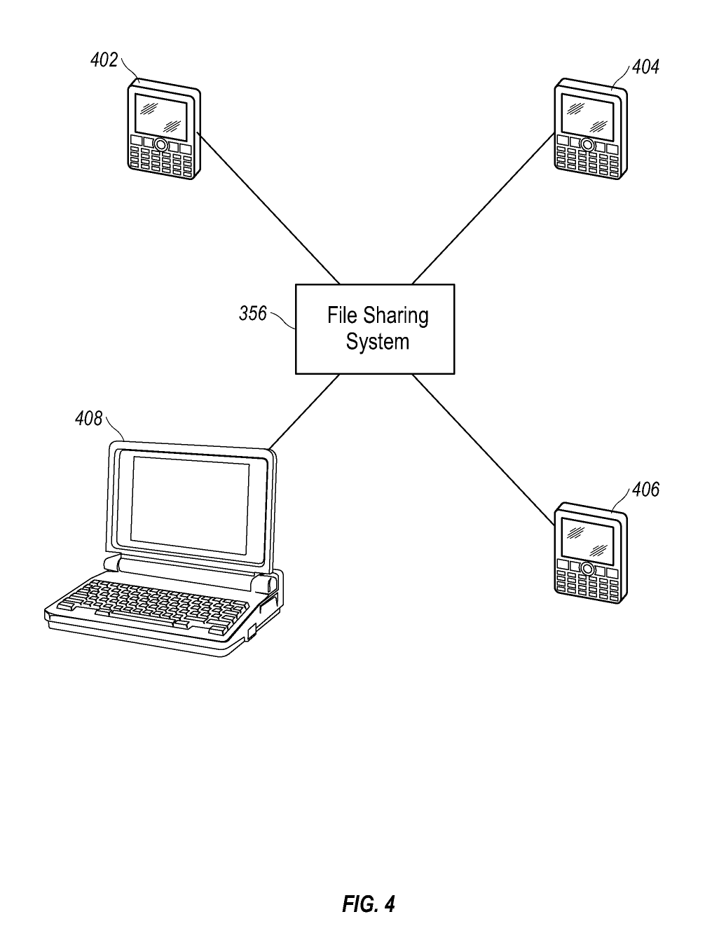

FIG. 4 illustrates an example embodiment of file sharing system 356, where three mobile communication devices 402, 404, 406 and one computer 408 (collectively, “devices”) share published content via the use of a file sharing system 356. The example embodiment shown in FIG. 4 and described herein is not limited to any specific number of computing devices and therefore the number of devices shown in FIG. 4 is merely an example. In one example embodiment, mobile device 402 represents a “content-requesting device”, e.g., a mobile communication device whose user wishes to search the content of other computing devices. Mobile devices 404 and 406 and computer 408 represent “content-storing devices”, e.g., devices, which could include mobile devices and computing devices, that store content, which can be made available for searching and sharing by mobile device 402. Mobile device 402, although designated in this example embodiment as a “content-requesting device” can also have content that can be made available for searching and sharing by other mobile devices. Thus, each mobile communication device 402, 404, 406 can be one or both of a content-requesting device and a content-storing device.

Mobile communication devices 402, 404, 406 can represent mobile phones each operated by a user. For example, device 402 can be operated by User A, device 404 can be operated by User B and device 406 can be operated by User C. Alternately, one user can operate more than one device and the user can be operating one device and wish to search and access content on the other device. For example, User A can use device 402 for his or her business and use device 404 for personal use. User A may be at the office and realize that he or she would like to search for an email address stored on their personal device, or access a calendar on their personal device. Similarly, User A can have his or her mobile device 402 at the office but would like to access content on his or her personal computer 408 at home.

In another example embodiment, a user wishes to present content that is stored on their mobile device at for example, a business meeting. For example, the user can have a PowerPoint presentation stored on his or her mobile device and the user may wish to make this content available to other participants in the meeting. In another example embodiment, a parental control feature is provided that allows parents who may wish to search and access the content stored on their son's or daughter's mobile device, or laptop computer, to do so.

As discussed above with respect to FIG. 3, mobile devices 402, 404, 406 can each include file sharing system 356. File sharing system 356 can therefore reside within one of the mobile devices as shown in FIG. 3 or can be a separate entity, as shown in FIG. 4. File sharing system 356 allows the mobile devices 402, 404 and 406 to exchange published content, e.g., information that is searchable and accessible to other mobile devices, with each other directly, i.e., via a peer-to-peer network, without the need to first join a social network or to have content stored on a central server. The published content could be in the form of actual data or metadata. The type of published content can be any type of information stored on a mobile device or a computer that other mobile communication device users may wish to access such as but not limited to music, photographs, ringtones, video, documents, calendars, and contact information. For example, the user of mobile device 402 may wish to search and access contact information that is stored in other computing devices. This can include email addresses, cell phone numbers, home or office telephone numbers, home or business addresses, and the like. This might occur in a scenario where, for example, User A, the user of mobile device 402 wants to contact an old friend, John Smith, but does not have his contact information. However, User A believes that the user of mobile device 404, i.e., User B, may have the contact information for John Smith. User A can contact User B via their respective mobile devices, thus allowing User A to search through the information that User B has elected to publish on mobile device 404, and determine if mobile device 404 contains contact information for John Smith. In this fashion, User A has “extended” his or her own address book to include the contacts from User B's address book.

File sharing system 356 can be implemented on a processor, with memory, storage devices, and the necessary input and output devices. The memory and storage devices represent computer-readable storage media that contains the software necessary to operate system 356. File sharing system 356 does not store the content that is to be searched and access but rather coordinates the file transfer between the content-requesting devices and the content-storing devices, coordinates permissions, as well as other tasks discussed in further detail below.

In one example embodiment, each mobile device that wishes to share its content with others registers its content with file sharing system 356. The registration process includes identifying providing permissions to other mobile devices, for example mobile device 402. By identifying and providing permissions to mobile device 402, file sharing system 356 provides mobile device 402 with the ability to access published content from other computing devices. For example, the user of mobile device 404 can forward a list of 20 friends and acquaintances, and their corresponding mobile phone numbers, to file sharing system 356. Of course, the amount of sharable information, e.g., the number of friends or acquaintances, is not limited in any way. File sharing system 356 grants permissions to all or some of the 20 mobile devices identified by mobile device 404. Subsequently, when a requesting mobile device wishes to access content from mobile device 404, file sharing system 356 checks its list of permissible mobile devices for mobile device 404 and if there is a match, the requesting mobile device can search mobile device 404 for published content. In this fashion, system 356 limits the availability of searchable content to only requesting devices that have been granted permission. Mobile devices having stored content can choose to register and de-register other mobile devices by contacting file sharing system 356 and adjusting its list of permissible mobile devices.

Thus, a user of a mobile device that was granted permission to access published content from another electronic device can contact another user and request access to stored content. Further, the stored contact can include a designator, where the designator indicates that only certain mobile devices are allowed to access certain content. Thus, the user can designate only certain authorized users to access specific published content. For example, stored contact information can be designated as “personal” or “business”. A user of a content-requesting device that has been designated as a “friend” may only access contact information designated as “personal” while a business associate may only access contact information designated as “business”. Other designations can be applied.

Mobile device 402 can access content from computing devices 404, 406, 408 in a number of ways. In one example embodiment, mobile device 402 transmits a search request via, for example, an electronic message, i.e., an email, a text message or an instant message, to mobile device 406. File sharing system 356 confirms that the requesting mobile device 402 has been granted permission to search the content of mobile device 404, and mobile device 402 is granted access to search and share file stored on mobile device 404. In another example embodiment, requesting mobile device 402 sends an electronic message directly to one or more of the content storing computing devices, i.e., mobile device 404, without the intervention of file sharing system 356. Mobile device 404 must then recognize and identify the requesting device and confirm that the requesting mobile device can freely search stored content on mobile device 404.

Content-storing devices, i.e. mobile device 404, can share its stored content with a requesting mobile device via one of any content-sharing technologies including, for example, BLUETOOTH®, Wi-Fi link, General Packet Radio Service (“GPRS”), Universal Mobile Telecommunications System (“UMTS”), Near Field Communication (“NFC”) protocol, location based services (“LBS”), or the like. A Universal Serial Bus (“USB”) connection can also be used to gain access to stored files. In one example embodiment, a requesting mobile device 402 can gain access to searchable content on mobile device 404, based on proximity. For example, User A may wish to search User B's music list for songs before User A departs on her long train ride to work. User A can travel together with User B in User A's car since they both need to be at the train station at the same time. Using near-field connectivity technologies such as, for example, BLUETOOTH®, content from User B's mobile device can be made available for searching and sharing when mobile device 402 is within a pre-determined distance, e.g., within a BLUETOOTH® enabled range from mobile device 404. Of course, User B can also search files stored on User A's device using the same near-field connectivity. Thus, in the preceding example, the file sharing capability can occur automatically, i.e., without an initial request for content, when two mobile devices are within a predetermined proximity of each other.

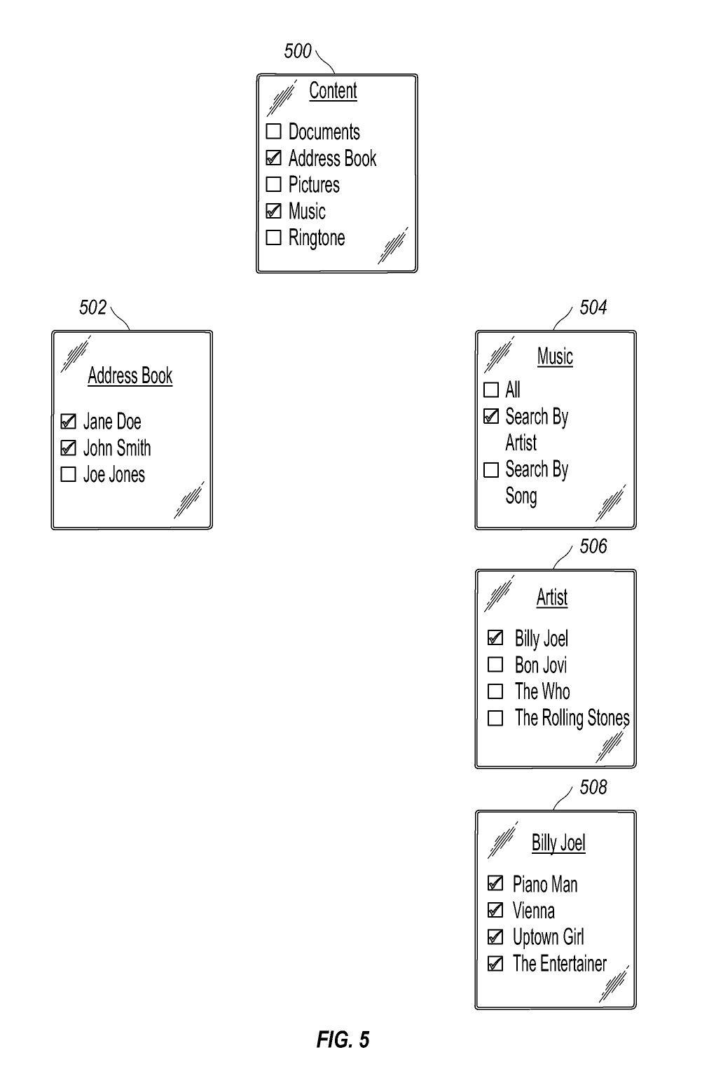

FIG. 5 illustrates an example embodiment where a content-storing mobile device, i.e., mobile device 404, wishes to make certain content available for search and access. FIG. 5 represents several example mobile device display screens that will enable the user of mobile device 404 to select which content can be searched and accessed by other, content-requesting mobile devices. User B of mobile device 404 may wish to allow other, registered mobile devices to access certain contacts of his or her address book, as well as selected musical artists, or songs. Presented with content screen 500, User B can select “Address Book” and “Music”. This provides User B with the ability to share all or some of the contents stored in their address book and music library, on mobile device 404. User B can select other types of content including, for example, documents, pictures, video, ringtones, etc. By selecting “Address Book”, User B is presented with an Address Book screen 502. From screen 502, User B can select which contact information is available for searching and access. User B can decide to publish all contact information in his or her address book, or only certain contacts.

File sharing system 356 provides the capability for the content-storing mobile device to selectively publish certain content depending upon the identity of the requesting mobile device. For example, User B may not wish to provide the contact information for Joe Jones to mobile device 402, but may allow this information to be searched and accessed by another mobile device, i.e., mobile device 406. Thus, mobile device 404 can select specific access control capabilities for each registered mobile device. User B can be presented with music screen 504 that allows User B to select particular musical artists or particular songs that it wishes to publish and make available for searching. User B can select “all”, thus allowing searching and access of all stored music, or limit selection to specific artists or songs. Thus, as shown in screens 506 and 508, User B wishes to make certain Billy Joel songs (i.e. “Piano Man”, “Vienna”, “Uptown Girl”, and “The Entertainer”) available for searching and access.

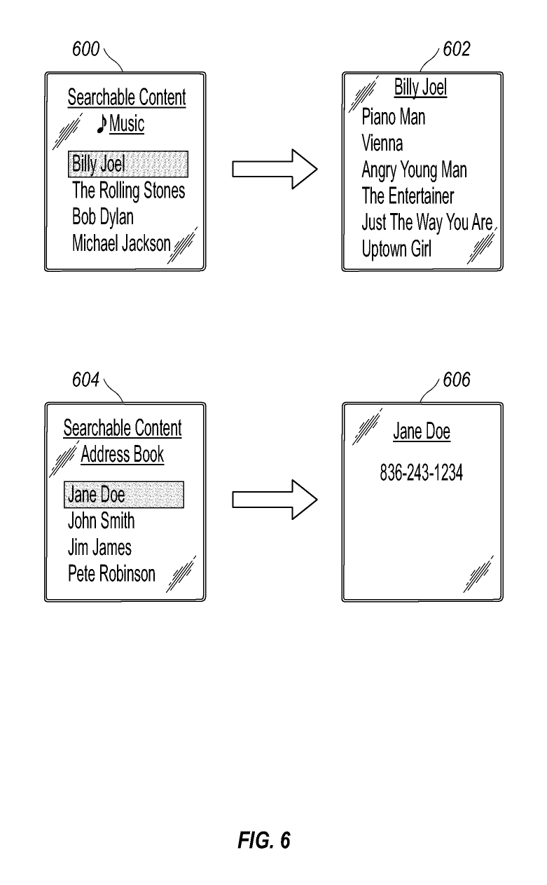

Once requesting mobile device, i.e., mobile device 402 has been granted permission to access select content stored on other computing devices, mobile device 402 display screen 600 can be presented to User A on their mobile device 402, as shown in FIG. 6. Screen 600 displays searching musical content that has been made available by one or more content-storing mobile devices. In one example embodiment, screen 600 can list all available musical content, sorted by artist. This list can include the songs already stored on the music library of mobile device 402 in addition to all other published songs made available by other content-storing devices. Or, separate screens can be provided in order to distinguish between content stored on mobile device 402 and content available for access on other, content-storing devices.

Thus, while mobile device 404 has only published content by one artist, Billy Joel, other content-storing mobile devices may have made published content available from other artists, as shown. While each of the artists is shown in the list format of screen 600, other formats are possible. For example, the identity of the mobile device that is making the content available can be listed next to each artist. In another example embodiment, User A is presented with a screen listing all of the songs made available by all content-storing mobile devices. In yet another example embodiment, User A is not presented with a listing of available content, but instead can actively search for a particular song or artist by typing in letters on their mobile device 402. For example, User A searches for the song “Dust in the Wind” by Kansas, by entering the first few letters of the song. If any of the content-storing devices have published this song, it will appear on the display of mobile device 402.

Referring again to FIG. 6, User A has selected Billy Joel and screen 602 is displayed on User A's mobile device 402, which lists all available songs (i.e. “Piano Man”, “Vienna”, “Angry Young Man”, “The Entertainer”, “Just The Way You Are”, and “Uptown Girl”)) by Billy Joel. Similarly, User A can be presented with screen 604 on User A's mobile device 402, which lists the names of published contacts from all other content-storing devices. Thus, while the user of mobile device 404 may have only decided to publish contact information for Jane Doe, the user of mobile device 406 may have decided to publish contact information for John Smith and Jim James, while the user of computer 408 has decided to publish contact information for Pete Robinson. Thus, each of these names appears on screen 604. Again, the organization of the information displayed on User A's mobile device 402 can vary. In an example, User A can start typing the letters J-A-N-E, and a listing of names having the first name of “Jane” will be displayed. User A can continue typing the letters D-O-E, until the name Jane Doe appears, along with her contact information (i.e. phone number 836-243-1234) as shown in screen 606, on User A's mobile device 402.

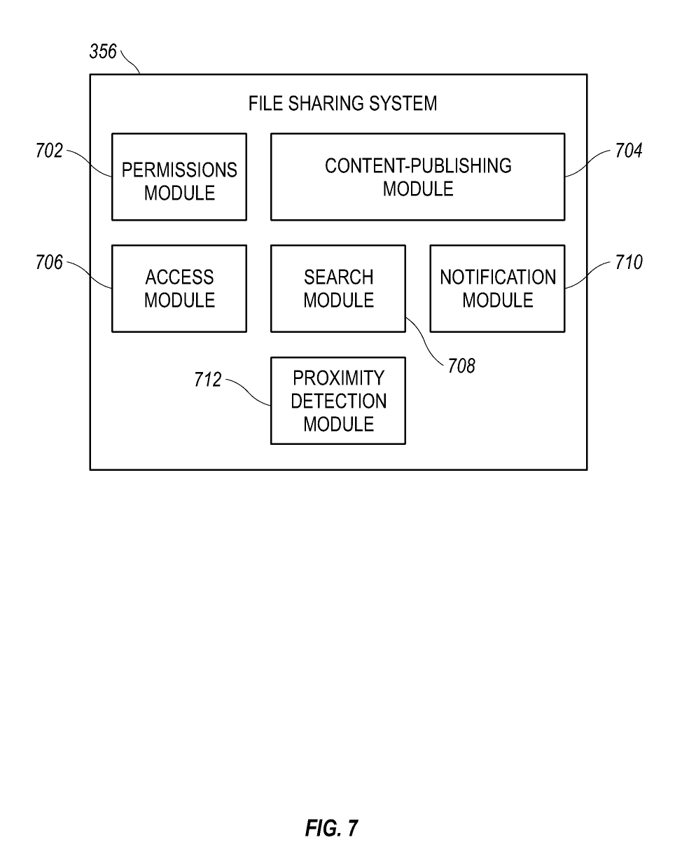

FIG. 7 shows the components of an example embodiment of file sharing system 356. Of note, the example embodiments disclosed herein support a file sharing system 356 that can include some or all of the modules depicted in FIG. 7. File sharing system 356 can be a separate entity as shown in FIG. 4, or may be included as a module within a mobile device as shown in FIG. 3 or may be part of the mobile device's processor 338. Some or all of the modules of file sharing system 356 communicate with each other. Permissions module 702 grants access permission to certain specified content-requesting devices in order for those devices to access the content stored on content-storage devices. For example, User B of mobile device 404 may only grant permission to User A of mobile device 402 but not grant permission to User C of mobile device 406. Thus, the user of the mobile device from which others will attempt to access published content has the choice of which mobile devices are to be granted with access privileges. Content-publishing module 704 includes the software and GUI to allow the user of the content-storing device to select which content is to be published, as discussed above with reference to FIG. 5. File sharing system 356 also includes an access module 706, which provides the content-requesting device with access to the published content, provided permissions module 702 has granted access to the content-requesting device. File sharing system 356 allows the user of the mobile device containing the content to override previous settings and permissions in order to grant, or deny accessing to a content-requesting device.

Search module 708 accepts search requests from content-requesting devices having access permission. The search request contains search parameters, and search module 708 is adapted to search for published content matching the search parameters. Access module 706 provides the content-requesting device with access to the published content matching the search parameters. Notification module 710 is used to notifying content-requesting devices that have gained access permission when new content is published by the content-storing device. The notification can occur via, for example, an email, a text message, or an automated call to the content-requesting devices. Thus, for example, User B operating content-storing device 406 need not wait for a search request from content-requesting device 402 but can instead notify device 402 by email, via notification module 710, when device 404 has new published content, for example, the contents of a new CD has been downloaded and stored on device 404. This notification can occur automatically, upon storage of the new content, or after a predetermined amount of time has elapsed. Further, notification module 710 need not notify each content-requesting device but may only notify select devices.

File sharing system 356 can also include a proximity detection module 712. Proximity detection module 712 includes a location-determining application, which can detect the presence of one or more other mobile communication devices within a predetermined distance. Proximity detection module 712 receives location information from one or more content-requesting devices and, by comparing it to the current location of the content-storing device, i.e., via a Global Positioning System (“GPS”) application, determines if one or more content-requesting devices are within a predetermined distance of the content-storing device.

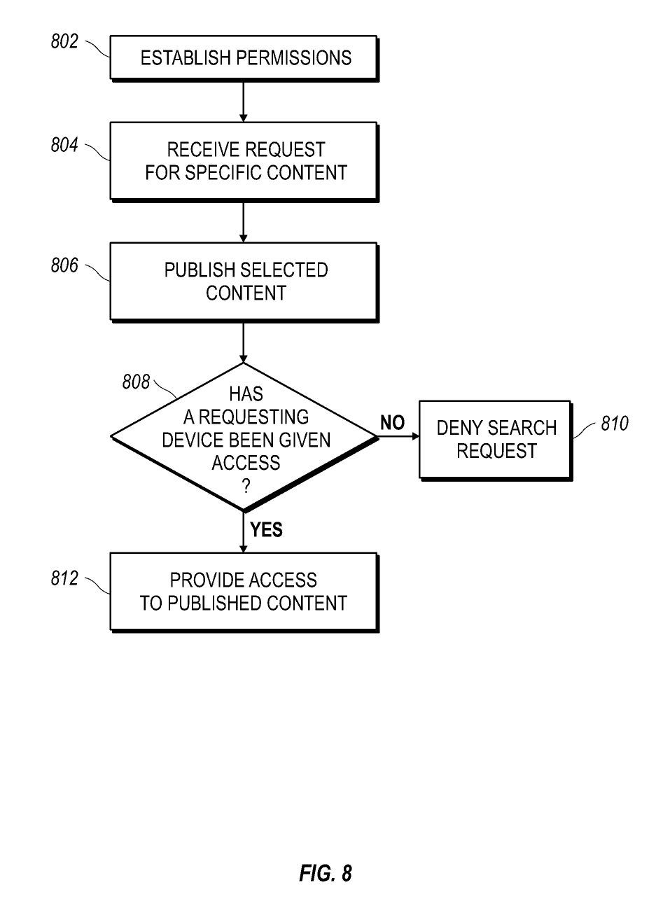

FIG. 8 illustrates the steps performed by an example embodiment of system file sharing 356. At step 802, access permissions are established. For example, permissions module 702 can establish access permissions by designating only those content-requesting mobile devices identified by the content-storage device. Thus, devices that store content can identify which content-requesting devices can access the published content. At step 804, a content-storing device receives a request from a content-requesting device for specific content. Step 804 is an optional step and, as discussed above, the content-storing device can publish and provide access to its content without waiting to receive a request. At step 806, the content-storing device publishes selected content that can be searched and accessed by content-requesting devices that have gained access permission.

At step 808, permissions module 702 determines if the content-requesting device has been granted access to the stored content. If not, at step 810, the search request is denied. Permissions module 702 can, optionally, notify the content-requesting device that they do not have the required permission to access the stored content. If the content-requesting device has been granted access then, at step 812, the content-requesting device is provided access to the stored content.

The example embodiments disclosed herein can be implemented using hardware or software in association with hardware. In some example embodiments, the software can include firmware, resident software, microcode, a Field Programmable Gate Array (FPGA) or Application-Specific Integrated Circuit (ASIC), etc. In particular, for real-time or near real-time use, an FPGA or ASIC implementation is desirable.

Furthermore, the example embodiments can take the form of a computer program product that includes program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. Both processors and program code for implementing each aspect of the example embodiments disclosed herein can be centralized or distributed (or a combination thereof) as known to those skilled in the art.

A data processing system suitable for storing a computer program product and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some example embodiments, the data processing system is implemented using one or both of FPGAs and ASICs.

I claim:

1. A method for sharing content between a content-storing device and a requesting mobile communication device, the method comprising:
granting access permission to at least one mobile communication device;
publishing selected content from content stored on the content-storing device, the published content available for searching by the requesting mobile communication device having access permission;
determining whether the requesting mobile communication device was granted permission to access the published content; and
if the requesting mobile communication device was granted permission to access the content, providing the requesting mobile communication device with access to the published content.

2. The computer-based method of claim 1, further comprising receiving, from the requesting mobile communication device, a search request for specific content from the published content.

3. The computer-based method of claim 1, wherein the stored content can be one or more of music, photographs, ringtones, video, documents, and contact information.

4. The computer-based method of claim 1, further comprising providing access permission for certain requesting mobile communication devices.

5. The computer-based method of claim 1, further comprising notifying requesting mobile communication devices that have gained access permission when new published content is published.

6. The computer-based method of claim 1, wherein providing the requesting mobile communication device with access to the published content occurs when the requesting mobile communication device is within a predetermined proximity of the content-storing device.

7. The computer-based method of claim 1, wherein the content-storing device is one of a mobile communication device and a computer.

8. The computer-based method of claim 1, wherein the requesting mobile communication device accesses the published content via a short range wireless communication protocol.

9. A communication system for sharing content, the system including at least one content-requesting device in communication with at least one content-storing device, the system comprising:
a permissions module for granting access permission to specified content-requesting devices in order to access content stored on the at least one content-storing device;
a content-publishing module for publishing content stored on the at least one content-storing device, the published content available for searching by the at least one content-requesting device having access permission; and
an access module for providing the at least one content-requesting device with access to the published content.

10. The system of claim 9, further comprising a search module for receiving a search request from the at least one content-requesting device having access permission, the search request containing search parameters, the search module adapted to search for published content matching the search parameters, the access module adapted to provide the at least one content-requesting device with access to the published content matching the search parameters.

11. The system of claim 9, wherein the stored content can be one or more of music, photographs, ringtones, video, documents, and contact information.

12. The system of claim 9, wherein the permissions module provides content access allowances for certain content-requesting devices.

13. The system of claim 9, further comprising a notification module for notifying content-requesting devices that have gained access permission when new content is published.

14. The system of claim 9, further comprising a proximity module, the proximity module adapted to determine when the at least one content-requesting device is within a predetermined proximity of the content-storing device, the access module providing the at least one content-requesting device with access to the published content when the at least one content-requesting device is within the predetermined proximity.

15. The system of claim 9 wherein the at least one content-storing device is one of a mobile communication device and a computer.

16. The system of claim 9, wherein the at least one content-requesting device accesses the published content via a short range wireless communication protocol.

17. A mobile communication device having stored content thereon, the mobile communication device comprising:
a permissions module for granting access permission to specified content-requesting devices in order to access the content;
a content-publishing module for publishing the content, the published content available for searching by the content-requesting device having access permission; and
an access module for providing the content-requesting device with access to the published content.

18. The mobile communication device of claim 17, further comprising a search module for receiving a search request from the at least one content-requesting device having access permission, the search request containing search parameters, the search module adapted to search for published content matching the search parameters, the access module adapted to provide the at least one content-requesting device with access to the published content matching the search parameters.

19. The mobile communication device of claim 17, wherein the stored content can be one or more of music, photographs, ringtones, video, documents, and contact information.

20. The mobile communication device of claim 17, further comprising a proximity module, the proximity module adapted to determine when the at least one content-requesting device is within a predetermined proximity of the content-storing device, the access module providing the at least one content-requesting device with access to the published content when the at least one content-requesting device is within the predetermined proximity.
